(19) United States
(12) Patent Application Publication
(10) Pub. No.: US 2018/0204250 A1
(43) Pub. Date: Jul. 19, 2018

(54) PREDICTIVE ATTRIBUTION-ADJUSTED BIDDING FOR ELECTRONIC ADVERTISEMENTS

(71) Applicant: CRITEO SA, Paris (FR)

(72) Inventors: Alexis Watine, Paris (FR); Clément Mennesson, Paris (FR); Eustache Diemert, Claix (FR); Julien Meynet, Grenoble (FR); Pierre Galland, Paris (FR); Damien Lefortier, Ivry la Bataille (FR)

(21) Appl. No.: 15/409,420

(22) Filed: Jan. 18, 2017

(51) Int. Cl. G06Q 30/02

(52) U.S. Cl. CPC G06Q 30/0275

(57) ABSTRACT

Methods and systems are described herein for predictive attribution-adjusted bidding for electronic advertisements. A bid determination computing device receives a bid request for an available impression opportunity on a website, and determines an initial opportunity value estimate for the available impression opportunity. The bid determination computing device identifies one or more interaction events associated with one or more prior impression opportunities for which the bid determination computing device submitted a winning bid, and determines a probability that a target outcome is attributable to at least one of the interaction events. The bid determination computing device adjusts the initial opportunity value estimate for the available impression opportunity based upon the determined probability, and transmits the adjusted opportunity value estimate to a remote computing device in response to the bid request.

### TECHNICAL FIELD

The present technology relates to electronic advertisements, and, more particularly, to techniques for predictive attribution-adjusted bidding for electronic advertisements.

### BACKGROUND

Publisher systems can provide webpages or other online content that can include one or more advertisement display opportunities for computerized graphical advertisement displays (e.g., space for a banner advertisement across the top of the webpage, within an application, or within other media such as videos or images). In some instances, when a user device (e.g., a computer running a web browser) processes a webpage for display, the user device can request, from an ad system, graphical display source code for a computerized graphical advertisement display for one of the advertisement display opportunities. The ad system can provide the graphical display source code to the user device to render and/or display.

As part of the advertisement selection process, the ad system communicates with real-time bidding (RTB) computing platforms. The RTB platforms receive bids from various third-party bidding agent systems (also called demand-side platforms (DSP)) that submit bids for the advertisement display opportunity on behalf of advertisers. Typically, the bidding agent systems are responsible for generating a bid for advertisement opportunities that meet the advertiser's requirements, such as cost, value, and audience considerations. The RTB platforms coalesce the bids received from the various DSPs and determine whether the advertisement display opportunity is selected after analyzing the received bids.

Generally, the RTB systems and DSPs participate in advertising auctions using a bidding strategy that optimizes revenue. An important factor in determining whether to participate in an auction is the predicted chance that a user takes some action with respect to the advertisement—e.g., views the ad, clicks on the ad, and the like. The occurrence of these types of actions is called an interaction event. Such interaction events can lead to subsequent target outcomes relating to the ad—for example, viewing product pages on an advertiser site, adding products to shopping cards on an advertiser site, purchases of products in the ad, signing up to mailing lists or newsletters, creating an account on the advertiser site, and so forth. Generally, advertisers are compensated when the target outcome can be matched to the interaction event on the advertisement for which the advertiser submitted the winning bid—also called attribution.

However, existing electronic advertisement bidding systems typically just submit auction bids based upon the predicted chance of an interaction event and/or target outcome occurring—without considering past auctions and their attribution characteristics. The expectation of attribution—i.e., the probability that a target event will be attributed to an advertisement associated with a winning bid—can have a significant impact on how much the advertiser should bid and therefore can directly affect the advertiser's revenue and profit.

### SUMMARY

Accordingly, there is a need for technology to dynamically and programmatically adjust opportunity value estimates (such as bids) in the computerized advertisement bidding process according to a predicted attribution probability that is based upon past auctions, the winning bids associated with them, and the corresponding attribution of those auctions.

In one aspect, there is a computerized method of predictive attribution-adjusted bidding for electronic advertisements. A bid determination computing device receives, from a remote computing device, a bid request for an available impression opportunity on a webpage. The bid determination computing device determines an initial opportunity value estimate for the available impression opportunity. The bid determination computing device identifies one or more interaction events associated with one or more prior impression opportunities for which the bid determination computing device submitted a winning bid. The bid determination computing device determines a probability that a target outcome is attributable to at least one of the interaction events. The bid determination computing device adjusts the initial opportunity value estimate for the available impression opportunity based upon the determined probability. The bid determination computing device transmits the adjusted opportunity value estimate to the remote computing device in response to the bid request.

The above aspect can include one or more of the following features. In some embodiments, the remote computing device is a real-time bidding platform, an ad exchange, an ad server, or a computing device executing an auction for the available impression opportunity within a browser. In some embodiments, the one or more interaction events include a view of the one or more prior impression opportunities. In some embodiments, the view is based upon viewability information of the one or more prior impression opportunities. In some embodiments, the one or more interaction events include a click of the one or more prior impression opportunities.

In some embodiments, the target outcome includes a sale associated with advertising content displayed in at least one of the available impression opportunity and the one or more prior impression opportunities. In some embodiments, the target outcome includes a marketing signup associated with advertising content displayed in at least one of the available impression opportunity and the one or more prior impression opportunities. In some embodiments, the target outcome includes an account creation associated with advertising content displayed in at least one of the available impression opportunity and the one or more prior impression opportunities. In some embodiments, the target outcome includes installation of a software application associated with advertising content displayed in at least one of the available impression opportunity and the one or more prior impression opportunities. In some embodiments, the target outcome includes a sale via an installed application associated with advertising content displayed in at least one of the available impression opportunity and the one or more prior impression opportunities.

In some embodiments, the probability is based upon an amount of time elapsed between an occurrence of at least one of the one or more interaction events and receipt of the bid request. In some embodiments, the step of determining the probability that a target outcome is attributable to at least one of the interaction events includes identifying user profile information associated with the one or more interaction events and determining the probability based in part upon the user profile information. In some embodiments, the step of determining the probability that a target outcome is attributable to at least one of the interaction events includes identifying advertising campaign information associated with the one or more interaction events and determining the probability based in part upon the advertising campaign information.

In some embodiments, the step of adjusting the initial opportunity value estimate comprises decreasing the initial opportunity value estimate by an amount dependent on the determined probability. In some embodiments, the bid determination computing device determines a difference between the determined probability and a probability that the target outcome is attributable to at least one of the interaction events if a winning bid is submitted for the available impression opportunity.

In some embodiments, the probability that a target outcome is attributable to at least one of the interaction events is based upon fractional attribution of at least one of the interaction events to the target outcome.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a networked system in accordance with embodiments of the technology.

FIG. 2 depicts a flow chart for predictive attribution-adjusted bidding for electronic advertisements.

### DETAILED DESCRIPTION

The present technology provides systems and methods for risk-adjusted predictive bidding for electronic advertisements, particularly computerized graphical display advertisements. Although the technology is illustrated and described herein with reference to specific embodiments, the technology is not intended to be limited to the details shown. Various modifications can be made in the details within the scope the claims and without departing from the technology.

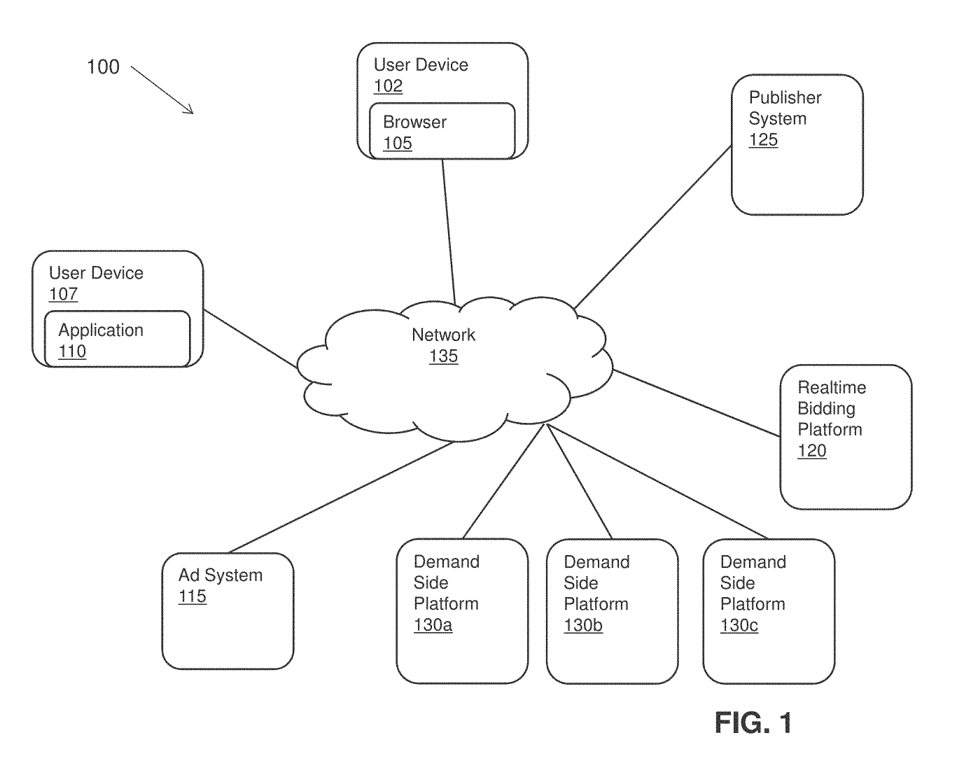

FIG. 1 is a diagram of networked system 100 in accordance with embodiments of the technology. As illustrated, networked system 100 can include user device 102, user device 107, ad system 115, RTB platform 120, publisher system 125, and DSPs 130a-130c. User device 102, user device 107, ad system 115, RTB platform 120, publisher system 125, and DSPs 130a-130c can be in data communication via network 135. User devices 102 and 107 can each be any computing devices. In some embodiments, user devices 102 and 107 can each be one of a mobile computing device (e.g., cellular phones and/or tablets), a PC, or other computing device. User device 102 executes web browser 105. User device 107 executes application 110 (e.g., a mobile application that interacts with online content).

Ad system 115 can be any computing device, such as a server or multiple servers. For example, ad system 115 can be an ad exchange, an ad server, or a computing device executing an auction locally within a browser. In some embodiments, ad system 115 can collect behavioral data for a plurality of devices, browsers, and/or applications. In some embodiments, ad system 115 can receive behavioral data for a plurality of devices, browsers, and/or applications from third-parties. In some embodiments, ad system 115 can provide graphical display source code for a computerized graphical advertisement display in accordance with the present technology.

RTB platform 120 can be any computing device, such as a server or multiple servers. In some embodiments, RTB platform 120 can perform auctions for advertising display opportunities in online media, such as webpages or application content served by publisher system 125, that are provided to user devices 102 and/or 107. Ad system 115 can submit bids for such advertising opportunities, and if ad system 115 wins the auction, ad system 115 can provide source code or other display data for a computerized graphical advertisement display to fill the advertising display opportunity. Publisher system 125 can be any computing device, such as a server or multiple servers. In some embodiments, publisher system 125 can serve webpages to browser 105. In some embodiments, publisher system 125 can serve other content to application 110. In some embodiments, publisher system 125 can communicate with ad system 115 to determine whether ad system 115 will provide source code for a computerized graphical advertisement display to fill an advertisement display opportunity in a webpage or application content.

DSPs 130a-130c can be any computing device, such as a server or multiple servers. In some embodiments, DSPs 130a-130c can receive bid requests from RTB platform 120 and generate opportunity value estimates, such as bids, on behalf of advertisers, which the DSPs 130a-130c then submit to the RTB platform in response to the bid requests. In some embodiments, the DSPs and RTB platform communicate using a specialized application programming interface (API), using specifically-formatted data requests and responses. Network 135 can be any network or multiple networks. For example, network 135 can include cellular networks through which user devices 102 and 107 are connected and the Internet.

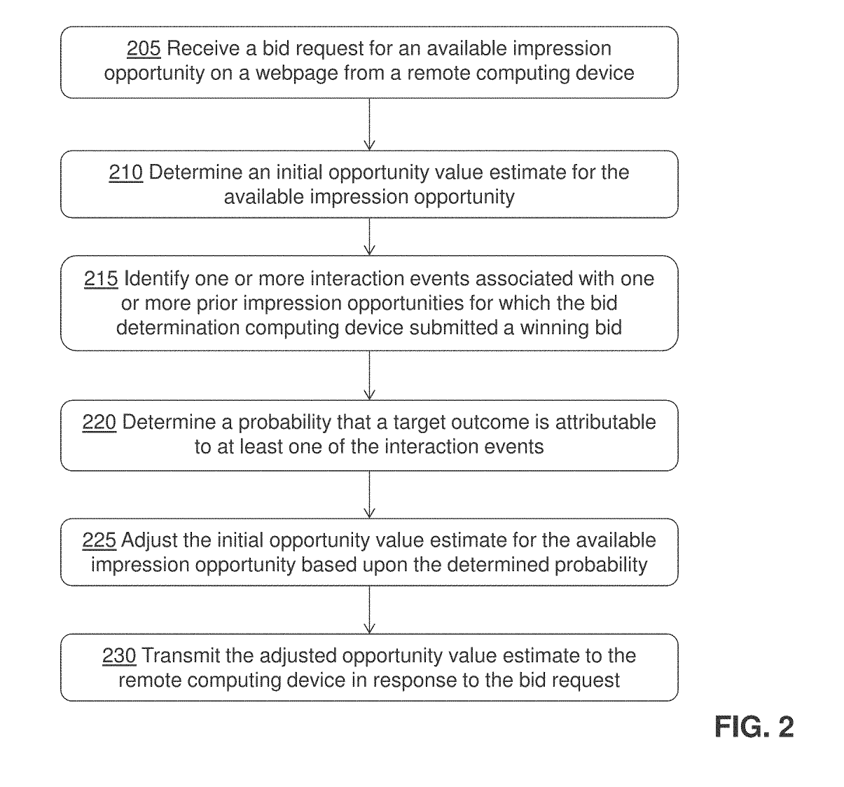

FIG. 2 is a flow diagram of a method of predictive attribution-adjusted bidding for electronic advertisements, using the system 100 of FIG. 1. An ad system (e.g., ad system 115) receives a request for graphical display source code for a computerized graphical advertisement display to be inserted into one or more impression opportunities on a webpage. The request can be received from a browser or other application executing on a user device (e.g., browser 105 on user device 102) on which the webpage is displayed. The ad system transmits the request to the real-time bidding platform 120 and, at step 205, the RTB platform 120 transmits the bid request to the DSPs 130a-130c for requisition of corresponding bids for the impression opportunity.

At step 210, each DSP 130a-130c determines an initial opportunity value estimate for the available impression opportunity. Generally, each of the DSPs provides an opportunity value estimate on behalf of an advertiser that wishes to insert a graphical advertisement into the impression opportunities on the webpage. The DSPs 130a-130c use the data elements contained in the bid request message to generate an initial opportunity value estimate that is responsive to the request for submission to the RTB platform 120.

At step 215, the DSPs 130a-130c identify one or more interaction events associated with one or more prior impression opportunities for which the DSP submitted a bid that won the corresponding advertising auction for which it was submitted. An interaction event includes actions such as views of an ad inserted into the impression opportunity, clicks of the ad, and so forth. For example, the DSP determines whether a click event occurred for a particular prior impression opportunity for which the DSP submitted the winning bid. In some embodiments, the DSP can determine whether the graphical advertisement displayed in the prior impression opportunity has one or more common characteristics with a graphical advertisement to be displayed in the available impression opportunity (e.g., similar or same products).

At step 220, the DSPs 130a-130c determine a probability that a target outcome is attributable to at least one of the identified interaction events. As mentioned previously, a target outcome can be a sale of a product (e.g., a product displayed in the graphical advertisement for which the interaction event occurred), a signup to an advertiser mailing list, an installation of a particular application or other piece of software on a computing device (such as a user's mobile device), a purchase or other transaction executed using an already-installed application (e.g., on the mobile device), or other similar sales or marketing outcomes. Using the techniques described herein, the DSPs can advantageously predict whether such a target outcome, if it occurs, will be attributable to an interaction event associated with one or more of the prior impression opportunities (or, in some embodiments, with the available impression opportunity).

As part of the probability determination, the DSPs can leverage a process whereby the DSPs gather historical information about, e.g., interaction events, impression opportunities, and target outcomes, to model the probability of attribution of a target outcome to one of the impression opportunities bid on by the DSP. For example, let S be a target outcome, let A be the attribution of the target outcome to the advertiser, and let X be a set of available information about the impression opportunities (e.g., campaign, partner, user profile, and the like). The DSPs can generate a probability model using this information: P(AIS, X). As an example of such a model, the DSPs can use a Linear Regression model, or in some embodiments, a Logistic Regression model: P(AlS, X)=1/(1+exp(<w,X>)) where w is the model weights as learned by, e.g., an optimization algorithm on historical data. In some embodiments, the optimization algorithm can be a Stochastic Gradient Descent or any other equivalent algorithm. One example of such an optimization algorithm is described in Bottou, Leon & Olivier Bousquet, “The Tradeoffs of Large Scale Learning,” Advances in Neural Information Processing Systems, NIPS Foundation (2008), pp. 161-168, which is incorporated herein by reference. It should be appreciated that, in some embodiments, the DSPs can perform the determination of the probability of a target outcome occurring and the determination of the probability of attribution of one or more events to the target outcome using one mathematical model as described herein. In some embodiments, more than one mathematical model is used (e.g., one model is used to determine the probability of a target outcome occurring and another model is used to determine the probability of attribution of one or more events to the target outcome).

It should be noted that due to the nature of the machine learning techniques utilized by the system described herein, it is necessary to implement the attribution probability model using a specialized processor—particularly because generation and execution of the attribution probability model requires access to historical/streaming data in large quantities, beyond that which general purpose computing devices are equipped to process. As described herein, in order to return meaningful results (i.e., an accurate prediction of probability) within a desired timeframe (e.g., milliseconds), the specialized processor must construct and traverse the attribution probability model with an efficient and optimized data structure. The importance of this construction is easily illustrated with a degenerate case: if the predicted attribution probability returned by the attribution probability model is always zero (or simply too low to produce a bid that could win the auction, or not returning an accurate probability within a specified period of time), then the bidding system would never win any auction and produce zero value. One way that the specialized processor can produce an accurate attribution probability model is to increase the number of training examples until the necessary accuracy level is attained. An example of such processing is described in Fernando Pereira, Peter Norvig, Alon Halevy, “The Unreasonable Effectiveness of Data,” IEEE Intelligent Systems, Vol. 24, p. 8-12, March/April, 2009, which is incorporated herein by reference.

One example of how the attribution probability can be modeled by the DSPs is related to an amount of time elapsed between the target outcome and one or more of the interaction events. It should be appreciated that generally, the less amount of time elapsed between the target outcome (e.g., a sale) and the last interaction event (e.g., an ad click) for an impression opportunity for which the DSP submitted the winning bid, the more probable it is that the target outcome is attributable to the last interaction event (and thus, attributable to the DSP's bid and advertiser). Therefore, the DSPs can employ such modeling techniques using time as an explaining variable to generate the attribution probability model.

An example of such a model incorporating the time information is a Logistic Regression model in which part of the X vector is filled with variables representing time, e.g.: time elapsed since last click, and the like. A number of transformations can be applied to these variables to enhance the predictive power, such as quantization (where the continuous variable is discretized by projection onto a number of fixed buckets) or exponentiation (where the variable is transformed by an exponential function with a suitable factor). The optimal value of the parameters of such transformations can be approximated by trial and error on historical data.

In some embodiments, the attribution probability model can be generated in advance of the auction for the available impression opportunity and can be updated at any number of different intervals (e.g., real-time, periodically) using additional information about interaction events, impression opportunities, and target outcomes as learned by the DSPs over time. In the case of a real-time update, the DSPs can use, e.g., an online learning algorithm that updates the model each time one or more learning examples are available. As an example, the attribution probability model can be the Stochastic Gradient Descent with mini-batch updates.

At step 225, the DSPs 130a-130c adjust the initial opportunity value estimate for the available impression opportunity based upon the determined probability that a target outcome will be attributable to at least one of the identified interaction events. In one example, the DSP can decrease the initial opportunity value estimate for an available impression opportunity by an amount that factors in the already-accumulated amount of attribution probability given by preceding impression opportunity auctions for which the DSP has submitted the winning bid—because the likelihood that a target outcome will be attributable to the available impression opportunity is less probable due to the amount of attribution probability allocated to the prior auctions and bids.

For example, if the DSP is using a last-click attribution paradigm and uses a predicted sale probability as one main component of the bidding strategy, the DSP can decrease subsequent opportunity value estimates by an amount that is a function of the difference between the attribution probability if an additional ad is shown to a user or not.

It should be appreciated that another use case of the attribution probability model described herein is to identify the underlying attribution scheme on the advertiser side. Such schemes can include multi-touch or fractional attribution, where the advertiser gives credit for a target outcome in the forms of fractions (which usually sum to 1) on different interaction events. In some cases, these advanced attribution schemes may involve cross-channel attribution where a target outcome may be partially credited to different kind of interaction events such as: a click on a marketing e-mail, a click on an advertisement banner or on a sponsored search result in a search engine, and the like. Comparing the model weights obtained from learning the attribution probability model on data from different advertisers can be used to identify the characteristics of the different attribution schemes. For instance, a model in which the weight of time based explaining variables is zero is a hint that the underlying attribution scheme used by the advertiser is not using any time considerations.

At step 230, once the DSPs have adjusted the opportunity value estimate based upon the determined probability to arrive at an updated bid, the DSPs transmit the updated opportunity value estimate to the RTB platform 120 for submission to the auction for the available impression opportunity. If the opportunity value estimate submitted by the DSP is selected as a bid by the RTB platform as the winning bid, the RTB platform generates graphical display source code to be inserted into the available impression opportunity. The RTB platform transmits the graphical display source code to the ad system for display on the user device

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application specific-integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A computerized method of predictive attribution-adjusted bidding for electronic advertisements, the method comprising:
receiving, by a bid determination computing device from a remote computing device, a bid request for an available impression opportunity on a webpage;
determining, by the bid determination computing device, an initial opportunity value estimate for the available impression opportunity;
identifying, by the bid determination computing device, one or more interaction events associated with one or more prior impression opportunities for which the bid determination computing device submitted a winning bid;
determining, by the bid determination computing device, a probability that a target outcome is attributable to at least one of the interaction events;
adjusting, by the bid determination computing device, the initial opportunity value estimate for the available impression opportunity based upon the determined probability; and
transmitting, by the bid determination computing device, the adjusted opportunity value estimate to the remote computing device in response to the bid request.

2. The method of claim 1, wherein the remote computing device is a real-time bidding platform, an ad exchange, an ad server, or a computing device executing an auction for the available impression opportunity within a browser.

3. The method of claim 1, wherein the one or more interaction events include a view of the one or more prior impression opportunities.

4. The method of claim 3, wherein the view is based upon viewability information of the one or more prior impression opportunities.

5. The method of claim 1, wherein the one or more interaction events include a click of the one or more prior impression opportunities.

6. The method of claim 1, wherein the target outcome includes a sale associated with advertising content displayed in at least one of the available impression opportunity and the one or more prior impression opportunities.

7. The method of claim 1, wherein the target outcome includes a marketing signup associated with advertising content displayed in at least one of the available impression opportunity and the one or more prior impression opportunities.

8. The method of claim 1, wherein the target outcome includes an account creation associated with advertising content displayed in at least one of the available impression opportunity and the one or more prior impression opportunities.

9. The method of claim 1, wherein the target outcome includes installation of a software application associated with advertising content displayed in at least one of the available impression opportunity and the one or more prior impression opportunities.

10. The method of claim 1, wherein the target outcome includes a sale via an installed application associated with advertising content displayed in at least one of the available impression opportunity and the one or more prior impression opportunities.

11. The method of claim 1, wherein the probability is based upon an amount of time elapsed between an occurrence of at least one of the one or more interaction events and receipt of the bid request.

12. The method of claim 1, wherein the step of determining the probability that a target outcome is attributable to at least one of the interaction events includes identifying user profile information associated with the one or more interaction events and determining the probability based in part upon the user profile information.

13. The method of claim 1, wherein the step of determining the probability that a target outcome is attributable to at least one of the interaction events includes identifying advertising campaign information associated with the one or more interaction events and determining the probability based in part upon the advertising campaign information.

14. The method of claim 1, wherein the step of adjusting the initial opportunity value estimate comprises decreasing the initial opportunity value estimate by an amount dependent on the determined probability.

15. The method of claim 14, further comprising determining, by the bid determination computing device, a difference between the determined probability and a probability that the target outcome is attributable to at least one of the interaction events if a winning bid is submitted for the available impression opportunity.

16. The method of claim 1, wherein the probability that a target outcome is attributable to at least one of the interaction events is based upon fractional attribution of at least one of the interaction events to the target outcome.

17. A computerized system of predictive attribution-adjusted bidding for electronic advertisements, the system comprising a bid determination computing device and a remote computing device, the system configured to:
receive, by the bid determination computing device from the remote computing device, a bid request for an available impression opportunity on a webpage;
determine, by the bid determination computing device, an initial opportunity value estimate for the available impression opportunity;
identify, by the bid determination computing device, one or more interaction events associated with one or more prior impression opportunities for which the bid determination computing device submitted a winning bid;
determine, by the bid determination computing device, a probability that a target outcome is attributable to at least one of the interaction events;
adjust, by the bid determination computing device, the initial opportunity value estimate for the available impression opportunity based upon the determined probability; and
transmit, by the bid determination computing device, the adjusted opportunity value estimate to the remote computing device in response to the bid request.
